(19) United States
(12) Patent Application Publication
(10) Pub. No.: US 2007/0247476 A1
(43) Pub. Date: Oct. 25, 2007

(54) Fast smooth up-sampling of binary volumes derived from medical imaging

(76) Inventors: Liron Yatziv, Plainsboro, NJ (US); Yiyong Sun, Lawrenceville, NJ (US); Chenyang Xu, Allentown, NJ (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/699,188

(22) Filed: Jan. 29, 2007

Related U.S. Application Data
(60) Provisional application No. 60/793,865, filed on Apr. 21, 2006.

(51) Int. Cl. G09G 5/00

(52) U.S. Cl. 345/611

(57) ABSTRACT

This invention describes a computer method of up-sampling (enlarging) a binary volume where the shapes and regions in the final up-sampled volume have smooth shapes and regions without the jagged edges exhibited in the up-sampled volumes processed by conventional methods. This up-sampling method is suitable for any multi-dimensional binary volumes including 3 dimensional medical imaging data.

### CROSS-REFERENCE TO RELATED CASES

This is a U.S. non-provisional application of U.S. provisional patent application Ser. No. 60/793,865, filed Apr. 21, 2006, by Yatziv et al., the entirety of which application is incorporated herein by reference.

### FIELD OF THE INVENTION

The present invention relates to a method for digital image data processing.

### BACKGROUND

As the medical imaging scanning technology advances, many medical imaging applications need to manage 3-dimensional images (i.e. CT, MRI) of ever-increasing resolution. These advanced medical imaging applications and systems require a variety of processing to be conducted on the digital image data (here denoted as binary volume) that are associated with such high resolution 3-dimensional images. As the image resolution increases, however, the size of the associated binary volume, also increases. But, the advances in the computer processing power has not kept pace with the demands of the medical imaging systems that need to analyze and process the ever-increasingly large binary volumes.

To compensate for the short comings of the computer processing power, the engineering solution has been to down-sample (shrink) the binary volume to a manageable size. But, the down-sampling process loses the fine details available in the full size volume and in practice loses the benefits of the latest scanning technology. Therefore, down-sampling of the binary volume is done only in the critical operations of image data processing applications where most data processing resources, such as memory, are necessary. Such critical operations are usually, operations such as segmentation, partition and classification that result in a binary volume that may be a binary mask or a binary partition/segmentation.

For example, some Electrophysiology (EP) applications require a segmentation of a heart. For large volumes such as CT scans, the segmentation algorithms require a large amount of memory. Running the segmentation algorithm on a down-sampled version of the CT scan data requires much less memory and also less processing time. The segmentation result is a binary mask indicating for each down-sampled pixel whether it belongs to the segmented object, in this case the heart, or to the back ground.

After the critical operation is completed, the binary volume (such as the binary mask in the CT example, needs to be up-sampled (magnified) back to the original size, so that other non-critical operations (operations that do not require peak data processing resources) such as visualization can process the binary volume at its full size. In a digital bitmapped volume representing a 3-dimensional image, the binary volume consists of 3D image elements, voxels (denoted herein as pixels), aligned on a grid. The volume resolution is the number of pixels present in each of the three dimensions. During up-sampling operation, when one or more of the binary volume's dimensions are magnified M times, the number of pixels in each magnified dimension is also increased M times. Since only the pixel values of the original pixels are known, the values of the newly created pixels must be calculated. To maintain the integrity of the full size 3-dimensional image as much as possible, the values for the newly created pixels have to be chosen in some intelligent way.

One of the known methods is trivial replication or nearest neighbor interpolation, which simply replicates the value of the nearest neighbor pixel. This causes the undesired effect of blockiness (agged edges). This effect is illustrated in a 2D image example shown in FIG. 2B. FIG. 2B is the image shown in FIG. 2A, up-sampled five times using the trivial replication method. As shown, the resulting image has very jagged edges. Other known linear methods (i.e. bilinear and bicubic interpolation) perform a linear operation on the pixel neighbors to determine the value of the newly created pixel. Other linear methods use higher order polynomials, B-splines, windowed sinc functions, etc. But all of these known up-sampling methods create extra artifacts, such as, blurring and/or ringing, etc. Those artifacts are visually disturbing and may interfere with the subsequent operations. Additionally, these linear methods are primarily applied on gray-scale binary volumes, and therefore, the binary volume must be converted to gray-scale which downgrades the performance. There are also other non-linear methods and morphological methods are designed to tackle the blockiness, however, they all require large memory and processor resources and they are not suitable for applications that require in-the-field data processing with limited processing and memory resources such as medical image processing.

Thus, there is a need for an improved up-sampling method that would solve the blockiness problem in the up-sampled volume which has substantially lower demand on the computer memory as well as processor's processing power.

### SUMMARY

According to an embodiment, a method for up-sampling of a binary volume is disclosed. The binary volume can be any multi-dimensional binary volume, e.g. 2-dimensional, 3-dimensional, 4-dimensional, 5-dimensional, etc. The method involves inserting a blank pixel hyperplane aligned with the volume grid perpendicular to the current work dimension axis into the binary volume between two existing pixel planes in a given dimension of the binary volume. The blank pixel hyperplane comprises an array of blank pixels, each blank pixel in the blank pixel hyperplane having one neighboring pixel in each of the two existing pixel planes. All pixels in the two existing pixel planes have a pixel value. Once a blank pixel hyperplane is inserted, for each of the blank pixels in the blank pixel hyperplane, the pixel values of the two neighboring pixels are compared to see whether they have the same values. If the two neighboring pixels have the same pixel values, that pixel value is assigned to the blank pixel, otherwise the blank pixels are left unassigned. Thus, once this comparing process is completed for the inserted blank pixel hyperplane, the inserted pixel hyperplane will consist of pixels that fall into one of two categories. One category is pixels having a pixel value assigned to each of them and a second category may be blank pixels that are yet to be assigned a pixel value.

Next, each of the unassigned blank pixels from the previous step are assigned with the pixel value of the nearest pixel in the blank pixel hyperplane that has an assigned pixel value. If there are more than one pixel that are closest to the blank pixel, then a predetermined anti-aliasing default value is assigned to the blank pixel. The anti-aliasing default value is arbitrarily predetermined to be a “1” or a “0.” And for a given blank pixel hyperplane, the same anti-aliasing default value is used for any blank pixels that fall in this situation. Preferably, after the pixel value assigning process for one blank pixel plane is completed, the anti-aliasing default value is flipped so that for the next blank pixel hyperplane, a different anti-aliasing default value is used.

Once all pixels in the blank pixel hyperplane have been assigned with a pixel value, next blank pixel hyperplane is inserted into the binary volume and the process described above for assigning the pixel values is repeated. This process is an iterative process that is repeated until a desired number of blank pixel hyperplanes are inserted into the binary volume in the given dimension. Generally, because a binary volume is a multi-dimensional volume, this whole process is reiterated for the next dimension in the binary volume that is to be extended (i.e. up-sampled). Once this up-sampling process is completed for every dimension in the binary volume that needs to be up-sampled, the binary volume will be in its final fully up-sampled dimension.

According to another aspect, disclosed is a program storage device readable by a machine, tangibly embodying a program of instructions executable by the machine to perform the method steps for up-sampling a binary volume described above. Unlike the conventional up-sampling methods currently available, the up-sampling method described herein provides an up-sampling solution particularly useful for binary volume derived from 3-dimensional medical images. It provides a good balance between performance and quality needed for medical applications. The currently available methods do not support 3-dimensional volumes or perform poorly (in terms of quality, speed performance and/or memory) on large volumes. This method is useful when performing time/memory consuming operations. The performance of those operations is improved when processing a down-sampling volume. The result can be up-sampled using this method which will avoid the blockiness artifacts (jagged edges) of the conventional trivial replication up-sampling. The advantage of the method described herein is its simplicity, speed and low memory demand on the computer processor. It supports up-sampling of each dimension of a binary volume to any size and is done directly on the binary voxels without the need for a gray-scale temporary volume. It provides a good balance between performance and quality, typically needed for medical imaging applications.

### BRIEF DESCRIPTION OF THE DRAWINGS

FIG. 1 is a flow diagram illustration of the up-sample method according to an embodiment.

FIGS. 2A-2C are 2-dimensional schematic illustrations of the beneficial effects of the up-sampling method according to an embodiment.

FIGS. 3A-3E illustrate the process of inserting a plane into a 3-dimensional binary volume as part of the up-sampling method according to an embodiment.

FIG. 3F is an illustration of the result of an up-sampling according to a prior art method.

FIG. 4 is a graphical illustration of an example of plane inserting order where the dimension size of a 3-dimensional binary volume is up-sampled three times.

FIGS. 5A-5C are illustrations of a multiplanar image reconstruction (plane slice) of a volume showing the beneficial effects of the up-sampling method according to an embodiment.

All drawings are schematic illustrations and the structures rendered therein are not intended to be in scale. It should be understood that the invention is not limited to the precise arrangements and instrumentalities shown, but is limited only by the scope of the claims.

### DETAILED DESCRIPTION OF THE INVENTION

The up-sampling method according to an embodiment of the invention is a morphological class method which may be applied to a binary volume of any number of dimensions. The method inserts blank pixel hyperplanes into the “work” volume starting with the original input binary volume. The process is an iterative process where one blank pixel hyperplane, representing a group of newly created blank pixels in one of the dimensions being extended, is inserted into the work volume aligned to the pixel grid perpendicular to the current work dimension axis and the values for each blank pixel in that blank pixel hyperplane are assigned an appropriate pixel value. Then, the process is repeated for each additional blank hyperplane inserted into the work volume until the necessary number of planes are inserted into the binary volume in a given dimension.

Additional blank pixel hyper planes in any dimension may be inserted until the final target size of the up-sampled binary volume is reached. To maintain the proper volume aspect ratio during the up-sampling process, the blank hyperplanes are preferably inserted at regular spacing (called mapping schemes), so the volume pixels reach their intended location in the up-sampled volume. The importance of the mapping scheme is same even in the conventional up-sampling methods and the mapping schemes discussed herein are already in use in conjunction with the conventional up-sampling methods.

There are several mapping schemes available to map the location of the volume pixels into their intended location. For example, linearly stretching the input binary volume so that the corner pixels of the input binary volume are placed at the corners of the up-sampled binary volume. Another example is to place the corner pixels of the input binary volume adjacent to the edges of the up-sampled binary volume (½ the input pixel spacing away from the volume edge). In medical imaging applications, the location of the pixels is particularly important therefore selecting the proper mapping scheme is important. When the down-sample scheme is known, the reverse scheme should be used. Otherwise, any one of the available mapping scheme can be used. Whatever the mapping scheme is used, the result is that new pixel planes are inserted into the work volume such that the new pixel planes are inserted evenly across the volume in any given extended dimension. Depending on the mapping scheme used, some planes may be inserted on the edge of the work binary volume, so they are not between two existing planes. For a plane inserted on the edge of the volume, the pixel values are directly copied from the adjacent plane and not calculated as done for the planes inserted in between two existing planes.

As used herein, the term “hyperplane” refers to a binary image data set that is one dimension less than the work binary volume. For example, where a multi-dimensional work binary volume is a 3-dimensional volume, a hyperplane associated with that work binary volume would be a 2-dimensional volume or a 2-dimensional plane. And where a multi-dimensional work binary volume is a 4-dimensional volume, a hyperplane associated with that work binary volume would be a 3-dimensional volume.

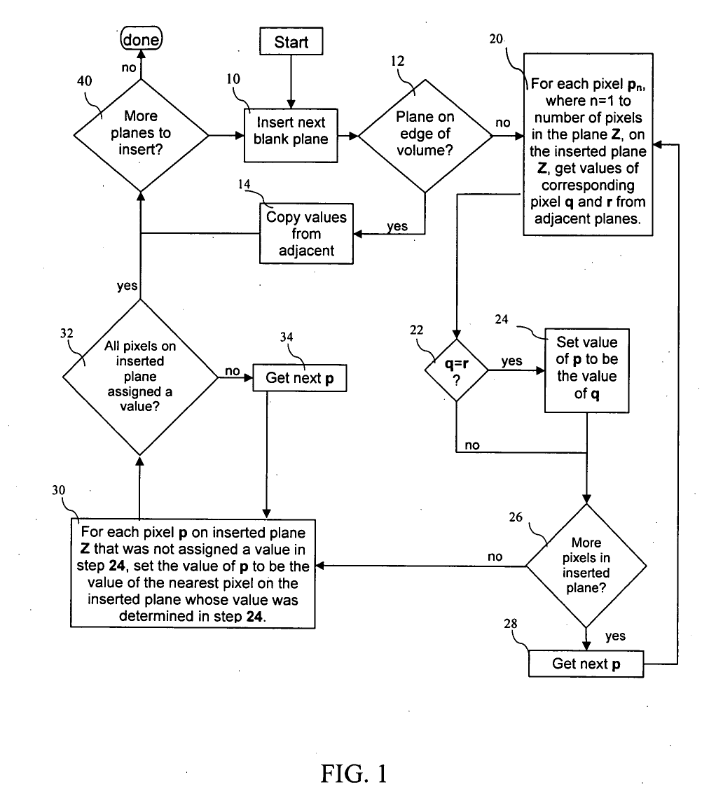

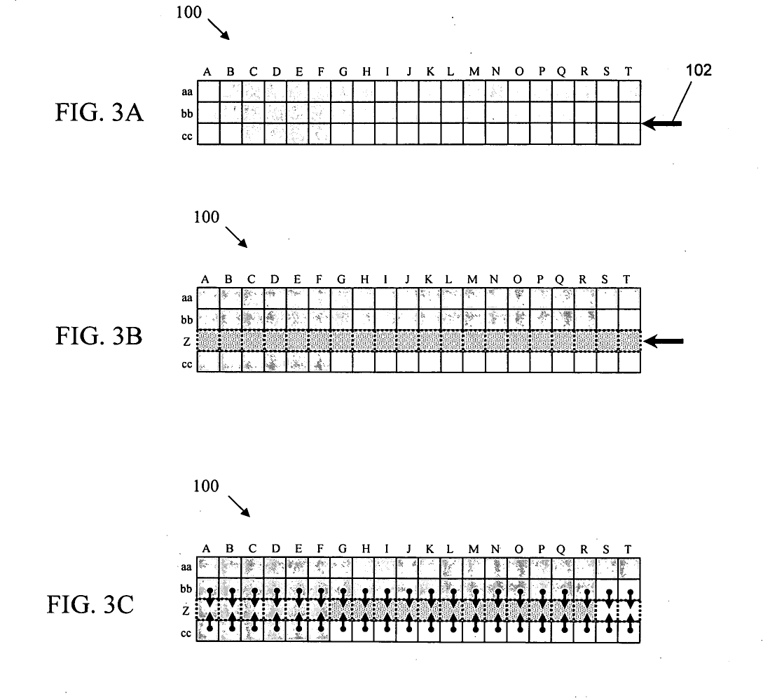

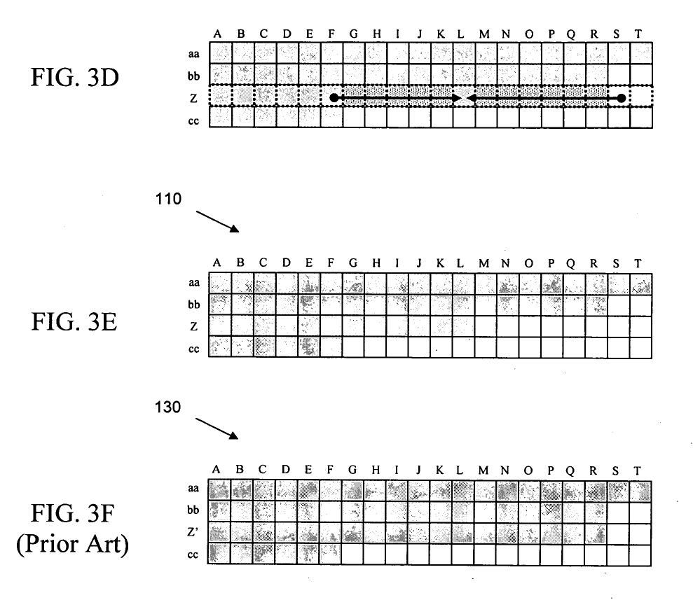

Referring to FIGS. 1 and 3A-3E an exemplary up-sampling method according to an embodiment is described. FIG. 1 is a flow chart of the up-sampling process according to an embodiment. FIGS. 3A-3E are 2-dimensional views of a set of pixel hyperplanes aa, bb and cc in a work binary volume 100 that will be used in conjunction with the flow chart of FIG. 1 to illustrate the up-sampling method. Effectively, these 2-dimensional views can be considered as cross-sectional views through the pixel hyperplanes aa, bb and cc.

At step 10, starting with an input binary volume 100 shown in FIG. 3A, a new blank pixel hyperplane is inserted at the location marked by the arrow 102. The term “blank” here is referencing the fact that the pixels in the pixel hyperplane being inserted do not have pixel values associated with them. The location for inserting the blank pixel hyperplane is determined by the particular mapping scheme implemented. There are several mapping schemes that can be used. Depending on the particular mapping scheme used, some mapping schemes do not allow new pixel hyperplanes to be added at the edge of the volume but in this example, to simplify the example, the mapping scheme used will be deemed not to allow new pixel hyperplanes to be added on the edge of the work volume 100. FIG. 3B shows the work volume 100 in which a new blank pixel hyperplane Z has been inserted between the pixel hyperplanes bb and cc as indicated earlier. Each of the pixels in the blank pixel hyperplane Z needs to be populated or assigned a value.

At step 12, the system checks to see whether the blank pixel hyperplane Z is on the edge of the work volume 100. If the inserted blank pixel hyperplane Z is on the edge of the work volume, at step 14, the pixel values are copied from the adjacent pixels. In other words, if the plane c did not exist so that the blank pixel hyperplane Z is on the edge of the work volume 100, the values for the pixels in the blank pixel hyperplane Z will simply be the copy of the pixel values in the adjacent pixel hyperplane bb. This is an iterative process until required number of pixel hyperplanes have been inserted and, thus, at step 40, the system checks to see whether additional planes have to be inserted. If the last pixel hyperplane in this cycle has been just inserted, the process ends. If more pixel hyperplanes need to be inserted, the system loop backs to the step 10 and the next pixel hyperplane is inserted. If the inserted plane is not on the edge of the work volume, as in the example shown in FIG. 3B (i.e., the blank pixel hyperplane Z is inserted between the pixel hyperplanes bb and cc) the system proceeds to next steps for determining the value for each of the pixels in the blank pixel hyperplane Z.

According to the steps 20, 22, 24, for each pixel pₙ in the newly inserted blank pixel hyperplane Z, where n=1 to total number of pixels in the plane, there are two adjacent pixels qₙ and rₙ in the adjacent existing pixel hyperplanes. The system assigns a value to the pixel pₙ that is equal to the adjacent pixels' values only if both of the adjacent pixels qₙ and rₙ have the same value. If the values of the pixels qₙ and rₙ are different, no value is assigned to the pixel pₙ. At the step 22, if the values for the pixels qₙ and rₙ are the same, the value of the pixel pₙ is set to the same value. If the values of the pixels qₙ and rₙ are different, no value is assigned to the pixel pₙ. This iterative process of assigning a value to the pixels in the newly inserted hyperplane continues until all pixels in the pixel hyperplane has been considered. So, at the step 26, if there are more pixels in the blank pixel hyperplane Z, then at the step 28, the system moves on to the next pixel pₙ and loops back to the step 20 and repeats the steps of determining the appropriate value for the pixel pₙ.

The example shown in FIG. 3C illustrates this process. In FIG. 3C, each of the pixels in the blank pixel hyperplane Z has two adjacent pixels, one in the pixel hyperplane bb and one in the pixel hyperplane cc. Different values in the pixels are shown by either the dark shading or blank white. As shown, the pixels Z-A, Z-B, Z-C, Z-D, Z-E and Z-F have adjacent pixels-that have the same values (represented by the dark shading) and thus, each of the pixels Z-A, Z-B, Z-C, Z-D, Z-E and Z-F are assigned the same values (represented by the dark shading). The pixels Z-S and Z-T also have adjacent pixels that have the same values (represented by blank white shading) and thus, these pixels are assigned the same values. The pixels Z-G, Z-H, Z-I, Z-J, Z-K, Z-L, Z-M, Z-N, Z-O, Z-P, Z-Q and Z-R have adjacent pixels in the hyperplanes bb and cc that do not have the same values and, thus, according to the process steps 20, 22, 24 and 26, these pixels do not get a value assigned.

Next, at step 30, for each pixel pₙ on the inserted blank pixel hyperplane Z that was not assigned a value, the value of the pixel pₙ is set to be the value of the nearest pixel on the inserted blank pixel hyperplane Z whose value has been assigned in the step 24. At step 32, if there are more pixels in the inserted blank pixel hyperplane Z that does not have an assigned value, the algorithm grabs the next pixel without an assigned value and repeats the step 30. This is shown in FIG. 3D. In FIG. 3D, for example, the unassigned pixels, Z-G, Z-H, Z-I, Z-J, Z-K, Z-L, Z-M, Z-N, Z-O, Z-P, Z-Q and Z-R are assigned the value of the nearest pixel in the pixel hyperplane Z, whose value was determined in the step 24. For example, for the pixel Z-L there are two pixels, Z-F and Z-S that were assigned a value in the step 24. But the pixel Z-S is seven pixels away from the pixel Z-L and the pixel Z-F is only six pixels away. Thus, the value of the closer pixel Z-F is assigned to the pixel Z-L. On the other hand, for the pixel Z-R, for example, the nearest pixel in the blank pixel hyperplane Z, whose value was determined in step 24 is pixel Z-S and, thus, the value of the pixel Z-S would be copied to the pixel Z-R. This process continues with all of the previously unassigned pixels until all of them gets a value assigned. The resulting final up-sampled work volume 110 is shown in FIG. 3E. For comparison, FIG. 3F shows an up-sampled work volume 130, that was up-sampled using conventional trivial replication method. In trivial replication method, the pixels in the new pixel hyperplane Z′ are simply copied from the adjacent pixel hyperplane bb. As shown, the final volume 110 up-sampled according to an embodiment of the invention results in a volume that has substantially eliminated the blockiness of the final volume produced by the prior art methods.

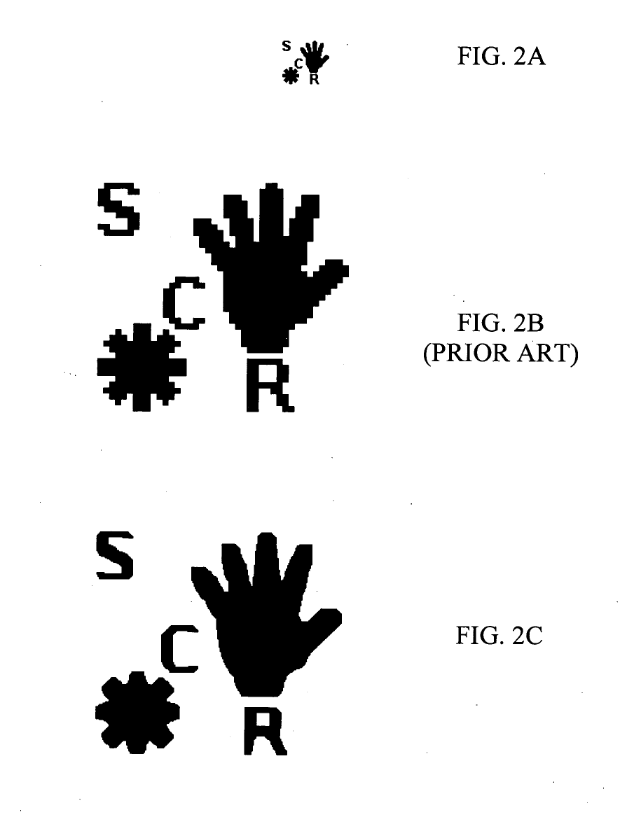

Although in FIGS. 3A-3E, 2-dimensional example is shown, note that this process in the step 30 requires measurement of distance on a plane when done in a true 3-dimensional work volume. The distance may be determined according to the application. For example, it may be sufficient to use the Manhattan distance, however, the Euclidian distance would produce better quality results. The pixel spacing may also be taken into account when measuring distance. When implementing, the distance can be measured on the fly for each pixel that needs to be filled in the step 30. Alternatively, the values set in the step 24 may be propagated using dynamic programming.

Once all pixels on the new blank hyperplane Z has been assigned a value, this iterative loop stops and goes to step 40 to determine whether or not more planes are to be inserted into the work binary volume 100. If an additional plane is inserted, the process described above is repeated. If no more planes are to be inserted, this cycle of plane inserting process is completed.

The process described above illustrates one cycle of up-sampling. If after one cycle of up-sampling, the work binary volume is not at the target size, additional cycles of up-sampling is conducted according to the process illustrated in FIG. 1 until the work binary volume reaches the target size.

When up-sampling a dimension of a work binary volume to more than double the scale, it is important that anti-aliasing should be taken into consideration. In the previous section, the step 30 copies the value of the nearest pixel value in the new plane. It may happen that there are more than one pixel with minimal distance, i.e. more than one pixel have the same closest distance to the particular blank pixel of concerₙ and also have been assigned a pixel value. When their values are also not unique, an anti-aliasing default value is used. Preferably, there should exist a separate default value for each extended dimension and are arbitrarily predetermined. This can be achieved by flipping the default value when a full cycle of plane insertion is completed in that dimension. In other words, if the anti-aliasing default value was initially arbitrarily determined to be a “1”, upon completion of one cycle of plane insertion, the anti-aliasing default value is flipped to a “0”. This flipping can be executed upon completion of each plane insertion cycle in one dimension, or upon completion of one full cycle of up-sampling.

A similar anti-aliasing effect can be achieved by preferring a pixel from a certain direction with respect to the blank pixel being assigned, when the minimal distance is not unique. For example, in FIG. 3D, if there were another plane between planes L and M so that a column of pixels LM existed between the column L and column M. The pixel Z-LM would be equidistant from pixels Z-F and Z-S. Therefore, there is not one but two pixels that are nearest to the pixel Z-LM which has a pre-assigned pixel value in the inserted blank pixel hyperplane Z. As an anti-aliasing measure, a preferred direction can be arbitrarily pre-selected so that either Z-F or Z-S, whichever is in the pre-selected preferred direction from the unassigned pixel Z-LM, will be selected and the pixel value of that pixel will be assigned to the unassigned pixel Z-LM. Thus, in this embodiment, the anti-aliasing default direction can be reversed upon completion of one full cycle of up-sampling. Alternatively, the anti-aliasing default direction can be reversed upon completion of a plane insertion process in any given dimension in which the binary volume is being extended. In 3-dimension, since there are four principal directions available in a given plane, the anti-aliasing default direction can be any one of the four principal directions and the anti-aliasing default directions can be reversed (i.e., 180 degrees) or rotated through the four principle directions.

The order in which the planes are inserted should not be arbitrary. The following order is preferred. As long as there are planes to be inserted according to the location mapping scheme, for each dimension to be extended, insert one plane between every two existing planes or at the edge of the volume, unless the location mapping scheme does not allow it, and flip the anti-aliasing default value for the extended dimension. The preference herein reflected is with respect to the number of planes inserted between any two existing planes at any given time.

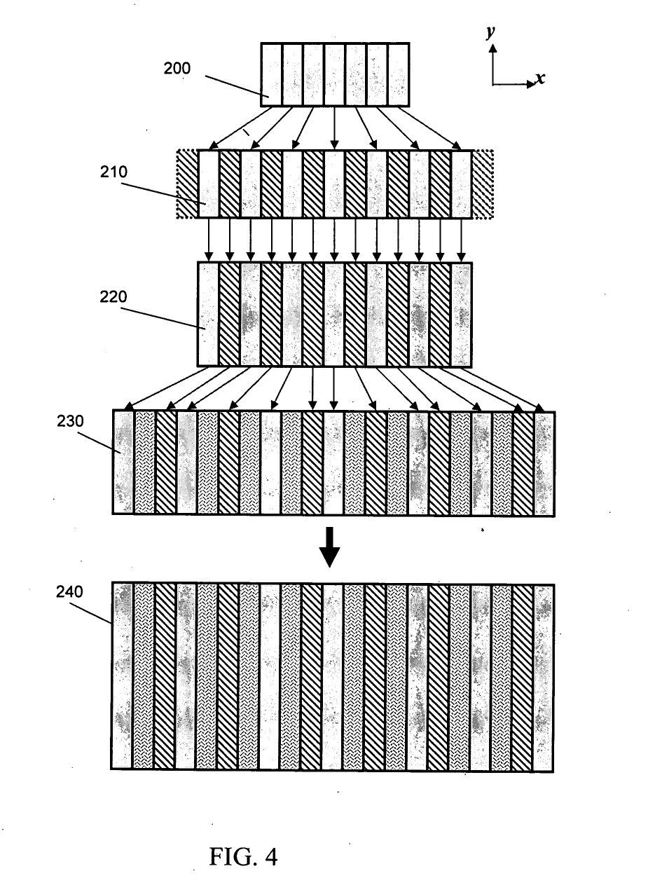

FIG. 4 shows an example of a two-dimensional view of a multi-dimensional work volume in which the work volume is up-sampled in two dimensions, x and y to triple the size of the volume. The original work volume 200 that has seven (7) planes is up-sampled to the final size 230 having twenty-one (21) planes (up-sampling in the x dimension) and each planes being triple the size of the planes in the original work volume 200 (up-sampling in the y dimension). The extension of the planes in the y dimension is illustrated in FIG. 4 as lengthening of the cross-sectional views of the planes.

In this example, the work volume 200 is processed through two cycles of up-sampling in each dimension (x and y) being extended to reach the final tripled size 230. First, during the first up-sampling cycle in the x dimension, new pixel planes (shown with the diagonal line-patterns) are inserted between every two existing planes in the original work volume 200. In this cycle, six (6) new pixel planes are inserted resulting in an interim work volume 210 having total of thirteen (13) pixel planes. Alternatively, if the particular location mapping scheme allows, new pixel planes can be inserted on the edges of the interim work volume 210 as shown by the two new pixel planes shown in broken lines. During this first up-sampling process, every time a pixel plane is inserted, the assignment of the pixel values for the pixels in the new pixel plane would be conducted according to the process described above in reference to FIGS. I and 4A-4E.

Next, before the second up-sampling cycle in the x dimension is conducted, first up-sampling cycle in the y dimension and up-sampling in any other dimension that requires growing is performed. Although, for simplicity of illustration, insertion of planes perpendicular to the illustrated planes are not shown, the extension in they dimension results in the interim work volume 220 whose planes are now larger and shown as being extended in the y dimension.

Next, in the second up-sampling cycle in the x dimension, in order to reach the targeted size of twenty-one (21) planes, eight (8) new pixel planes are inserted into locations determined by the particular location mapping scheme in to the interim volume 220 resulting in the work volume 230 having twenty-one (21) pixel planes. Whatever the location mapping scheme is used, the scheme should insert the necessary pixel planes into the work volume as evenly distributed as possible. Next, the second up-sampling cycle in they dimension is performed generating the final work volume 240 that has tripled in size from the original work volume 200 in both the x and y dimensions to increase the size of the planes in the y dimension. At this point, other dimensions may continue to grow if necessary.

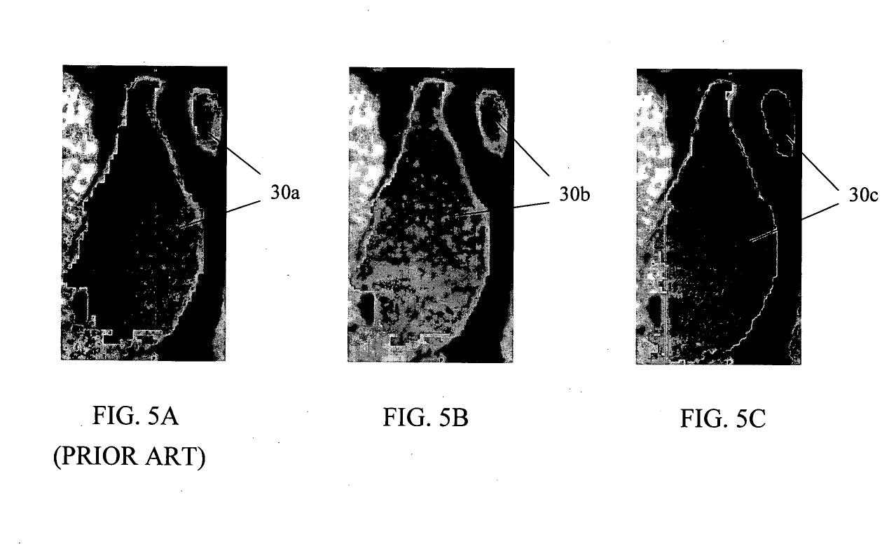

Referring to FIGS. 5A-5C, the three images present multiplanar image reconstruction (MPR) or a plane slice of the volume where the highlighted regions 30a, 30b, 30c visualizes a 3-dimensional segmentation result. The highlighted region 30a in FIG. 5A is a visualization of a region that was segmented in lower resolution (i.e. down-sampled binary volume) and then up-sampled using the trivial replication method. As shown, the region 30a exhibits coarse jagged edges. The highlighted region 30b in FIG. 5B is a visualization of the same region that was segmented in lower resolution but up-sampled using the method of an embodiment of the present invention. For comparison, the highlighted region 30c in FIG. 5C shows the same region that was segmented in the full scale volume without going through down-sampling and up-sampling steps. Unlike the highlighted region 30a, the highlighted region 30b in FIG. 5B has smooth edges and it is not obvious to the viewer that the segmentation was performed on a down-sampled binary volume and then up-sampled.

The invention described herein can be automated by, for example, tangibly embodying a program of instructions upon a storage media, readable by a machine capable of executing the instructions. A general purpose computer is an example of such a machine. Examples of the storage media are well know in the art and would include such devices as, a readable or writable CD, flash memory chips (e.g. thumb drives), various magnetic storage media, etc.

The essential features of the invention having been disclosed, further variations will now become apparent to persons skilled in the art. All such variations are considered to be within the scope of the appended claims. Reference should be made to the appended claims, rather than the foregoing specification, as indicating the true scope of the subject invention.

What is claimed is:

1. A method for up-sampling of a multi-dimensional binary volume comprising:
(a) inserting a blank pixel hyperplane into the multi-dimensional binary volume between two existing pixel hyperplanes in a given dimension of the multi-dimensional binary volume, the blank pixel hyperplane comprising an array of blank pixels, each blank pixel in the blank pixel plane having one neighboring pixel in each of the two existing pixel hyperplanes, wherein all pixels in the two existing pixel hyperplanes have a pixel value;
(b) comparing the pixel value of the two neighboring pixels for each blank pixel in the blank pixel hyperplane;
(c) assigning the pixel value of the neighboring pixels to the blank pixel only where the two neighboring pixels have the same pixel values;
(d) for each unassigned blank pixel from step (c), assigning the pixel value of the nearest pixel in the blank pixel hyperplane having an assigned pixel value to the unassigned blank pixel until all pixels in the blank pixel hyperplane have an assigned pixel value; and
(e) repeating the steps (a)-(d) until a desired number of blank pixel hyperplanes are inserted into the multi-dimensional binary volume in the given dimension.

2. The method of claim 1, further comprising the step of assigning an anti-aliasing default value to the unassigned blank pixel when there are more than one nearest pixel identified in step (d).

3. The method of claim 2, further comprising the step of flipping the anti-aliasing default value after the desired number of blank pixel hyperplanes are inserted into the binary volume in the given dimension.

4. The method of claim 1, further comprising the step of repeating the steps (a)-(e) subsequent to completion of the step (e) in which blank pixel hyperplanes are inserted into the binary volume between two existing planes in a different dimension.

5. The method of claim 4, further comprising the step of assigning an anti-aliasing default value to the unassigned blank pixel when there are more than one nearest pixel identified in step (d).

6. The method of claim 5, further comprising the step of flipping the anti-aliasing default value after the desired number of blank pixel hyperplanes are inserted into the binary volume in the given dimension.

7. The method of claim 4, further comprising the step of pre-selecting an anti-aliasing default direction and when there are more than one nearest pixel identified in step (d), assigning the pixel value of the nearest pixel that is in the anti-aliasing default direction from the unassigned blank pixel.

8. The method of claim 7, further comprising the step of reversing the anti-aliasing default direction after the desired number of blank pixel hyperplanes are inserted into the binary volume in the given direction.

9. A method of claim 1, wherein the multi-dimensional binary volume is a 3-dimensional binary volume and the pixel hyperplanes are 2-dimensional pixel planes.

10. A program storage device readable by machine, tangibly embodying a program of instructions executable by the machine to perform method steps for up-sampling a multi-dimensional binary volume, the method steps comprising:
(a) inserting a blank pixel hyperplane into the binary volume between two existing pixel hyperplanes in a given dimension of the binary volume, the blank pixel hyperplane comprising an array of blank pixels, each blank pixel in the blank pixel hyperplane having one neighboring pixel in each of the two existing pixel hyperplanes, wherein all pixels in the two existing pixel hyperplanes have a pixel value;
(b) comparing the pixel value of the two neighboring pixels for each blank pixel in the blank pixel hyperplane;
(c) assigning the pixel value of the neighboring pixels to the blank pixel only where the two neighboring pixels have the same pixel values;
(d) for each unassigned blank pixel from step (c), assigning the pixel value of the nearest pixel in the blank pixel hyperplane having an assigned pixel value to the unassigned blank pixel until all pixels in the blank pixel hyperplane have an assigned pixel value; and
(e) repeating the steps (a)-(d) until a desired number of blank pixel hyperplanes are inserted into the binary volume in the given dimension.

11. The apparatus of claim 10, wherein the method steps further comprising the step of assigning an anti-aliasing default value to the unassigned blank pixel when there are more than one nearest pixel identified in step (d).

12. The apparatus of claim 11, wherein the method steps further comprising the step of flipping the anti-aliasing default value after the desired number of blank pixel hyperplanes are inserted into the binary volume in the given dimension.

13. The apparatus of claim 10, wherein the method steps further comprising the step of repeating the steps (a)-(e) subsequent to completion of the step (e) in which blank pixel hyperplanes are inserted into the binary volume between two existing hyperplanes in a different dimension.

14. The apparatus of claim 13, wherein the method steps further comprising the step of assigning an anti-aliasing default value to the unassigned blank pixel when there are more than one nearest pixel identified in step (d).

15. The apparatus of claim 14, wherein the method steps further comprising the step of flipping the anti-aliasing default value after the desired number of blank pixel hyperplanes are inserted into the binary volume in the given dimension.

16. The apparatus of claim 10, wherein the method steps further comprising the step of pre-selecting an anti-aliasing default direction and when there are more than one nearest pixel identified in step (d), assigning the pixel value of the nearest pixel that is in the anti-aliasing default direction from the unassigned blank pixel.

17. The apparatus of claim 16, wherein the method steps further comprising the step of reversing the anti-aliasing default direction after the desired number of blank pixel planes are inserted into the binary volume in the given direction.

18. The apparatus of claim 10, wherein the multi-dimensional binary volume is a 3-dimensional binary volume and the pixel hyperplanes are 2-dimensional pixel planes
